(19) United States
(12) Patent Application Publication
(10) Pub. No.: US 2025/0132648 A1
(43) Pub. Date: Apr. 24, 2025

(54) MAGNET INSERTION DEVICE

(71) Applicant: TOYOTA BOSHOKU KABUSHIKI KAISHA, Aichi-ken (JP)

(72) Inventor: Hiroyuki SAIKI, Toki-shi (JP)

(73) Assignee: TOYOTA BOSHOKU KABUSHIKI KAISHA, Aichi-ken (JP)

(21) Appl. No.: 18/912,758

(22) Filed: Oct. 11, 2024

(30) Foreign Application Priority Data
Oct. 19, 2023 (JP) 2023-180310

(51) Int. Cl. H02K 15/03

(52) U.S. Cl. CPC H02K 15/03; H02K 2215/00

(57) ABSTRACT

A magnet insertion device includes a magazine, a pusher, an aligning member, and an insertion mechanism. The magazine includes a housing body and an extruding portion configured to move magnets in the housing body in a stacking direction to sequentially extrude the sets of the magnets from the housing body. The pusher is configured to move each set of the magnets by collectively pushing the set of the magnets. The aligning member is configured to align the magnets in each set by coming into contact with opposite sides in the arrangement direction of the set of the magnets when the magnets are pushed and moved by the pusher. The insertion mechanism is configured to collectively grip each set of aligned magnets and insert the magnets into a magnet housing hole.

### CROSS-REFERENCE TO RELATED APPLICATIONS

This application is based upon and claims the benefit of priority from prior Japanese Patent Application No. 2023-180310, filed on Oct. 19, 2023, the entire contents of which are incorporated herein by reference.

### BACKGROUND

### 1. Field

The present disclosure relates to a magnet insertion device.

### 2. Description of Related Art

Japanese Laid-Open Patent Publication No. 2022-23737 discloses a rotor assembling apparatus for inserting permanent magnets into slots of a rotor core.

The rotor assembling apparatus includes a robotic arm and a load sensor. The robotic arm includes a magnet holding portion at the distal end. The magnet holding portion clamps and holds a permanent magnet. The load sensor is attached to the magnet holding portion. The load sensor measures the load acting on the permanent magnet held by the magnet holding portion.

The robotic arm moves the permanent magnet toward the opening of a slot in order to insert the permanent magnet held by the magnet holding portion into the slot. At this time, if the permanent magnet is misaligned with respect to the slot, the permanent magnet comes into contact with the rotor core, so that a load acts on the permanent magnet. When the load acting on the permanent magnet exceeds a load limit, the movement of the permanent magnet by the robotic arm is stopped. The robotic arm then moves the permanent magnet such that the permanent magnet can be inserted into the slot. Then, again, the robotic arm moves the permanent magnet towards the opening of the slot. When the load applied to the permanent magnet does not exceed the load limit, the permanent magnet is inserted into the slot.

Some rotors have a configuration in which multiple permanent magnets are inserted into each slot in a state in which the magnets are arranged in a direction orthogonal to the axial direction of the rotor. In this case, in order to improve the productivity of the rotor, it is preferable that multiple permanent magnets be collectively inserted into a slot. However, in a case in which the magnet holding portion holds multiple permanent magnets and inserts the permanent magnets collectively into a slot, if the permanent magnets have not been aligned in advance, the magnet holding portion collectively holds the misaligned permanent magnets. In this case, due to the interference between the permanent magnets and the rotor core, the magnet holding portion may have difficulty in smoothly inserting the permanent magnets into the slot. Therefore, it is desirable to align multiple permanent magnets in advance when inserting the permanent magnet into a slot.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a magnet insertion device is configured to insert sets of magnets into magnet housing holes formed in a rotor core. The magnet insertion device includes a magazine, a pusher, an aligning member, and an insertion mechanism. The magazine includes a housing body and an extruding portion. The housing body has an ejection port and is configured to house multiple magnets in a stacked state. The extruding portion is configured to move the magnets in the housing body in a stacking direction to sequentially extrude the sets of the magnets from the housing body through the ejection port in a state in which the magnets in each set are arranged side by side. The pusher is configured to move, in a direction different from the stacking direction, each set of the magnets by collectively pushing the magnets extruded to the outside of the housing body. The aligning member is configured to align the magnets in each set by coming into contact with opposite sides in the arrangement direction of the set of the magnets when the magnets are pushed and moved by the pusher. The insertion mechanism is configured to collectively grip the magnets in each set that have been aligned by the aligning member, and to insert the magnets into one of the magnet housing holes.

Other features and aspects will be apparent from the following detailed description, the drawings, and the claims.

### BRIEF DESCRIPTION OF THE DRAWINGS

FIG. 1 is a plan view showing a rotor according to an embodiment.

FIG. 2 is a schematic diagram showing a magnet insertion device according to the embodiment.

FIG. 3 is a perspective view of the magnet insertion device shown in FIG. 2.

FIG. 4 is an enlarged view mainly illustrating an aligning member shown in FIG. 2.

FIG. 5 is a front view showing a state in which an insertion mechanism shown in FIG. 2 grips magnets.

FIG. 6 is a schematic diagram showing a state in which a first camera shown in FIG. 2 is capturing an image of magnets.

FIG. 7 is a schematic diagram showing a state in which the insertion mechanism shown in FIG. 2 is inserting magnets into a magnet housing hole.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

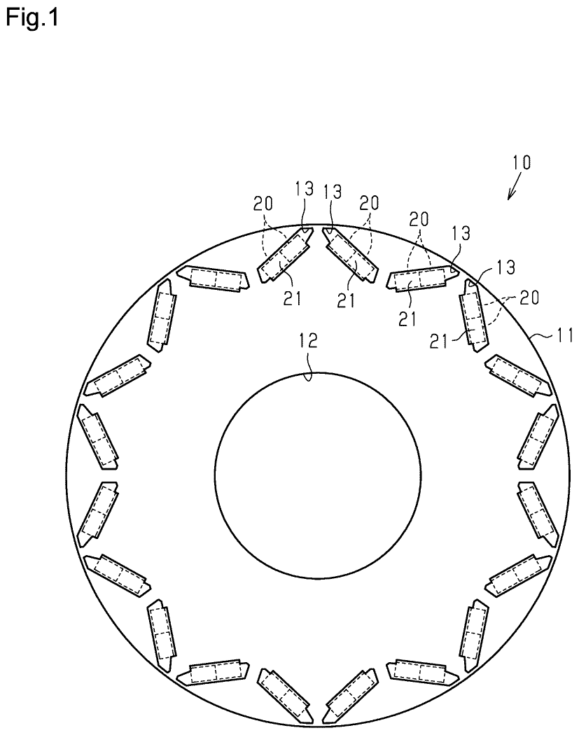

A magnet insertion device 30 according to an embodiment will now be described with reference to FIGS. 1 to 7.

The magnet insertion device 30 is a device used for manufacturing a rotor 10 used in a magnet-embedded motor.

### Rotor 10

First, the rotor 10 will be described.

As shown in FIG. 1, the rotor 10 includes a rotor core 11, multiple magnets 20, and multiple plastic members 21.

### Rotor Core 11

The rotor core 11 is substantially cylindrical.

In the following description, the axial direction of the rotor core 11 will simply be referred to as an axial direction. The radial direction of the rotor core 11 will simply be referred to as a radial direction. The circumferential direction of the rotor core 11 will simply be referred to as a circumferential direction.

The rotor core 11 is formed, for example, by stacking iron core pieces that are punched out from a magnetic steel sheet.

The rotor core 11 includes a center hole 12 and magnet housing holes 13. A shaft (not shown) is inserted into the center hole 12. Magnets 20 are accommodated in the magnet housing holes 13. The center hole 12 and the magnet housing holes 13 extend through the rotor core 11 in the axial direction.

The magnet housing holes 13 are located on the outer side in the radial direction of the center hole 12 and located at equal intervals in the circumferential direction. The opening of each magnet housing hole 13 has a substantially rectangular shape in plan view. Any two of the magnet housing holes 13 that are adjacent to each other in the circumferential direction are inclined in opposite directions with respect to the circumferential direction.

### Magnets 20

The magnets 20 each have the shape of a quadrangular prism. Each magnet 20 has a rectangular cross section that is orthogonal to the length direction. The rectangular cross-sectional shape has long sides and short sides.

Hereinafter, a cross section orthogonal to the length direction of the magnets 20 may be simply referred to as a cross section.

For example, multiple magnets 20 are accommodated in each magnet housing hole 13. In the present embodiment, a set of magnets 20, which includes two magnets 20, is accommodated in each magnet housing hole 13 in a state in which the magnets 20 are arranged in a long-side direction of the magnet housing hole 13, which is a direction orthogonal to the axial direction. The magnets 20 in each set are arranged in a state in which end faces forming the short sides in a cross section are in contact with or face each other. Each set of the magnets 20 is fixed to the rotor core 11 with a plastic member 21 filling the corresponding magnet housing hole 13.

The magnets 20 are, for example, permanent magnets, such as neodymium magnets.

### Plastic Members 21

For example, the plastic members 21 each fill the gap between the inner surface of the magnet housing hole 13 and the outer surfaces of the corresponding set of the magnets 20

The plastic members 21 may be made of, for example, a thermosetting plastic such as an epoxy plastic, or a thermoplastic such as a liquid crystal polymer.

### Magnet Insertion Device 30

Next, the magnet insertion device 30 will be described.

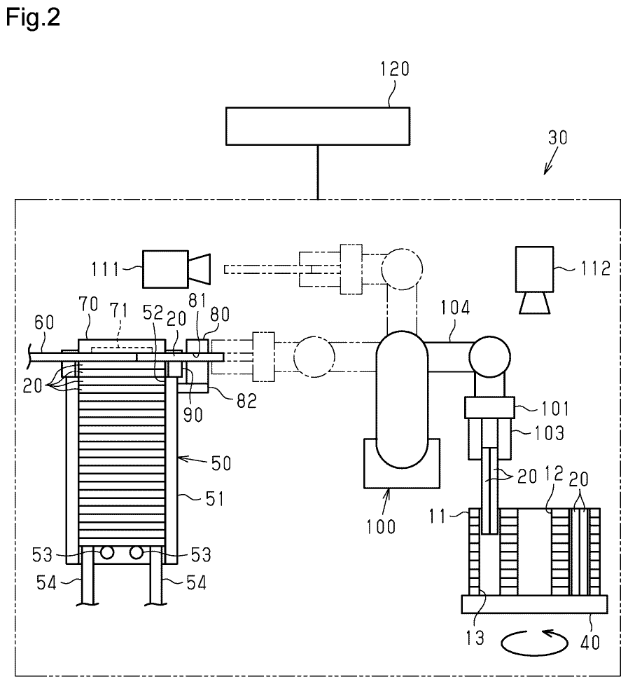

As shown in FIG. 2, the magnet insertion device 30 includes a support base 40, a magazine 50, a pusher 60, a pressing member 70, an aligning member 80, a guide member 90, an insertion mechanism 100, a first camera 111, a second camera 112, and a control unit 120.

### Support Base 40

The support base 40 supports the lower surface of the rotor core 11 in a state in which the rotor core 11 is fixed to the support base 40. The support base 40 is configured to rotate the rotor core 11 by a desired rotation angle around the central axis of the rotor core 11.

### Magazine 50

The magazine 50 includes a housing body 51, two support portions 53, and two extruding portions 54. The housing body 51 houses multiple magnets 20 in a stacked state. The two support portions 53 support the lowermost set of the magnets 20 stacked inside the housing body 51 from below. The two extruding portions 54 extrude a set of the magnets 20 to the outside of the housing body 51.

The housing body 51 houses sets of the magnets 20 stacked in the vertical direction. In each set, the magnets 20 are arranged in the horizontal direction. The housing body 51 has a tubular shape with an ejection port 52. The ejection port 52 is opened in an upper portion of the housing body 51. In each set of magnets 20, which are adjacent to each other in the horizontal direction inside the housing body 51, end faces that form the short sides in a cross section are in contact with each other.

Hereinafter, the direction in which the magnets 20 in each set are arranged may simply be referred to as an arrangement direction.

The support portions 53 are provided in a lower portion of the housing body 51 so as to be spaced apart from each other in the length direction of the sets of the magnets 20. Each of the support portions 53 has, for example, a columnar shape elongated in the arrangement direction.

The extruding portions 54 move the magnets 20, stacked inside the housing body 51, in the stacking direction, thereby sequentially extruding one set of the magnets 20 to the outside of the housing body 51 through the ejection port 52 in a state in which the magnets 20 are arranged side by side.

The extruding portions 54 are respectively disposed on the opposite sides of the support portions 53 in the length direction of the magnets 20. Each extruding portion 54 has, for example, the shape of a column elongated in the vertical direction. The extruding portions 54 push, from below, opposite end portions in the length direction of the lowermost set of the magnets 20, stacked inside the housing body 51. The extruding portions 54 are connected to an actuator (not shown) that moves up and down in the vertical direction. When the extruding portions 54 are raised by the actuator, the magnets 20 are extruded one set at a time to the outside of the housing body 51 through the ejection port 52.

### Pusher 60

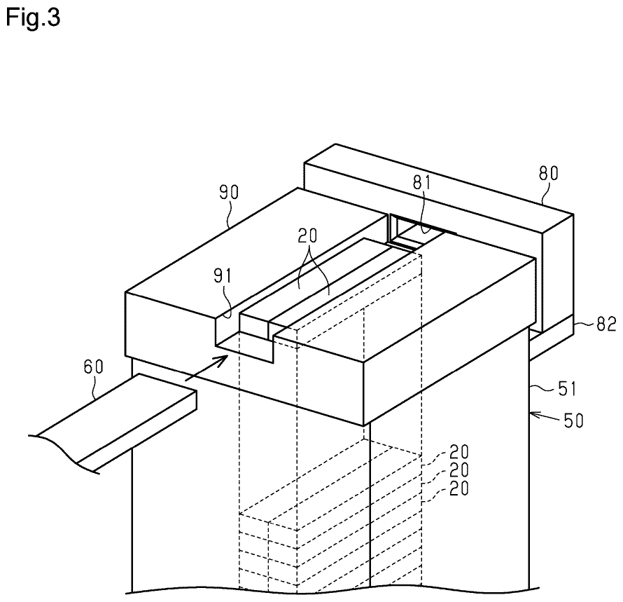

As shown in FIG. 3, the pusher 60 pushes and moves, in a direction different from the stacking direction of the magnets 20, a set of the magnets 20 that has been extruded to the outside of the housing body 51. Specifically, the pusher 60 pushes a set of the magnets 20 in the longitudinal direction of the magnets 20, which is orthogonal to the stacking direction of the magnets 20. This causes one set of the magnets 20 to slide in the longitudinal direction.

The pusher 60 pushes a set of the magnets 20 when the set of the magnets 20, which has moved with movement of the extruding portions 54, is located at a push position. The push position is a position at which a set of the magnets 20 can be moved in the longitudinal direction by being pushed by the pusher 60, and is a position at which the lower surface of the uppermost set of the magnets 20 is at the same level as or higher than the bottom surface of a guide groove 91, which will be discussed below. The pusher 60 advances to push a set of the magnets 20 and then retracts to push the next set of the magnets 20.

### Pressing Member 70

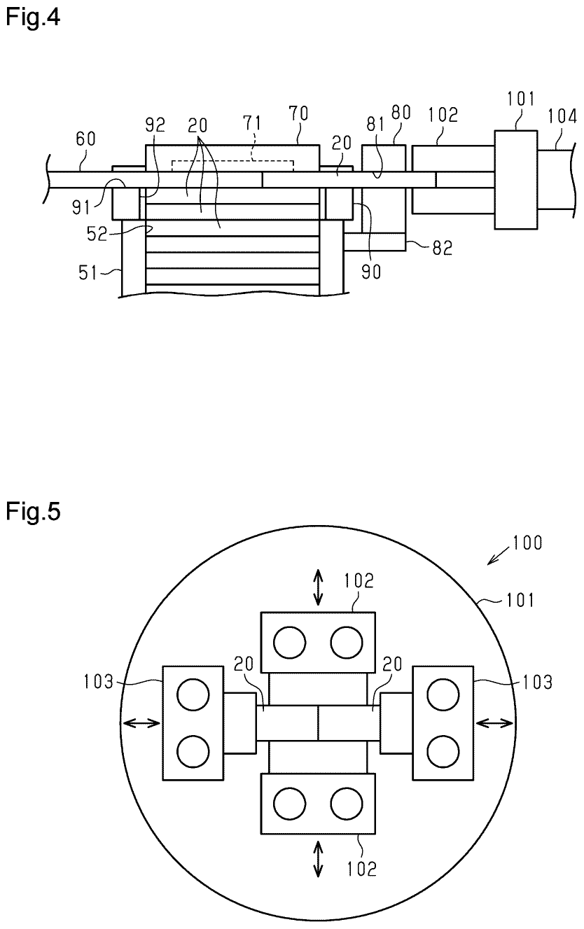

As shown in FIG. 4, the pressing member 70 presses down a set of the magnets 20 that is pushed and moved by the pusher 60, from above, which is one side in the stacking direction. The pressing member 70 is disposed at a position facing the ejection port 52 above the ejection port 52. The pressing member 70 comes into contact with the set of the magnets 20 located at the push position from the side opposite to the extruding portions 54. Therefore, the push position can be described as a position at which a set of the magnets 20 that has moved with movement of the extruding portions 54 comes into contact with the pressing member 70.

The pressing member 70 incorporates a proximity sensor 71. The proximity sensor 71 detects that a set of the magnets 20 has come into contact with the lower surface of the pressing member 70.

When the proximity sensor 71 detects that a set of the magnets 20 has come into contact with the lower surface of the pressing member 70, the extruding portions 54 stop moving the magnets 20.

### Aligning Member 80

As shown in FIG. 3, the aligning member 80 aligns a set of the magnets 20 that is being pushed and moved by the pusher 60.

The aligning member 80 is disposed on the opposite side of the magazine 50 from the pusher 60. The aligning member 80 is coupled to the housing body 51 with a bracket 82.

The aligning member 80 has a passage port 81, through which a set of the magnets 20 pushed by the pusher 60 passes. The passage port 81 has a rectangular opening. An opening edge on the inlet side of the passage port 81 is chamfered over the entire circumference.

When a set of the magnets 20 passes through the passage port 81, the inner surface of the passage port 81 comes into contact with the opposite sides in the arrangement direction of the set of the magnets 20. This aligns the set of the magnets 20 in the arrangement direction. Also, when a set of the magnets 20 passes through the passage port 81, the inner surface of the passage port 81 comes into contact with the opposite sides in the vertical direction of the set of the magnets 20. This aligns the set of the magnets 20 in the vertical direction. As described above, a set of the magnets 20 is aligned by sliding on the inner surface of the passage port 81 when passing through the passage port 81.

### Guide Member 90

The guide member 90 guides a set of the magnets 20, which is pushed and moved by the pusher 60, toward the aligning member 80.

The guide member 90 covers an upper end portion of the housing body 51. The guide member 90 has a guide groove 91 extending over the entire guide member 90 in the pushing direction of the pusher 60. The guide groove 91 faces the passage port 81 of the aligning member 80 in the pushing direction of the pusher 60. The width of the guide groove 91 is set to be greater than or equal to the width of the passage port 81.

As shown in FIG. 4, a part of the upper opening of the guide groove 91 is closed by the pressing member 70. The guide groove 91 and the pressing member 70 define a space that allows a set of the magnets 20 to move.

A set of the magnets 20 that is pushed and moved by the pusher 60 is restricted from being displaced in the arrangement direction by the guide groove 91. Accordingly, the set of the magnets 20 is guided to the passage port 81 of the aligning member 80.

A connection hole 92, which is connected to the ejection port 52 of the housing body 51, is formed in the bottom surface of the guide groove 91. The magnets 20 in the housing body 51 move to the push position by passing through the ejection port 52 and the connection hole 92.

### Insertion Mechanism 100

As shown in FIG. 2, the insertion mechanism 100 collectively grips a set of the magnets 20 aligned by the aligning member 80 and inserts the magnets 20 into a magnet housing hole 13 of the rotor core 11.

The insertion mechanism 100 includes a chuck 101 and a robotic arm 104. The chuck 101 grips a set of the magnets 20. The chuck 101 is attached to the robotic arm 104.

As shown in FIG. 5, the chuck 101 includes a pair of first gripping portions 102 and a pair of second gripping portions 103. The pair of the first gripping portions 102 grips the boundary portion of a set of the magnets 20 from the opposite sides in a direction orthogonal to both the pushing direction of the pusher 60 and the arrangement direction. The pair of the second gripping portions 103 grips the set of the magnets 20 from the opposite sides in the arrangement direction. The first gripping portions 102 thus come into contact with the surfaces that form the long sides in a cross section of each magnet 20. The second gripping portions 103 come into contact with the surfaces that form the short sides in a cross section of the magnets 20. A contact area between the first gripping portions 102 and the set of the magnets 20 is larger than a contact area between the second gripping portions 103 and the set of the magnets 20. The gripping force of the pair of the first gripping portions 102 is greater than the gripping force of the pair of the second gripping portions 103.

As shown in FIG. 4, the insertion mechanism 100 grips an end portion of a set of the magnets 20 protruding from the passage port 81 of the aligning member 80. At this time, the insertion mechanism 100 grips the set of the magnets 20 by the pair of the second gripping portions 103 and then the pair of the first gripping portions 102.

The robotic arm 104 is capable of moving the set of the magnets 20 to a desired position by moving and rotating the chuck 101.

### First Camera 111

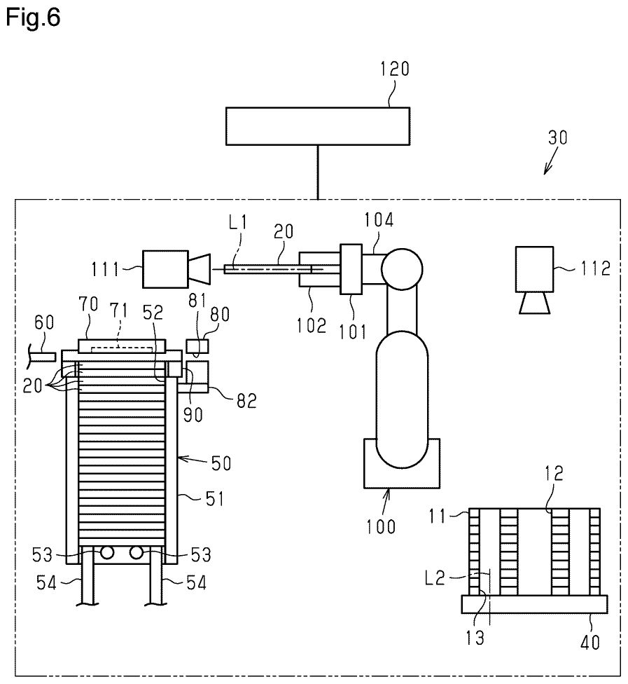

As shown in FIG. 6, the first camera 111 captures an image of an end face of an end portion of a set of the magnets 20 gripped by the chuck 101 at the side opposite to the gripped portion. The end face of the set of the magnets 20, the image of which is captured by the first camera 111, is an end face of the set of the magnets 20 in the insertion direction of the insertion mechanism 100.

### Second Camera 112

The second camera 112 is disposed above the support base 40. The second camera 112 captures an image of the upper surface of the rotor core 11 including the magnet housing holes 13.

### Control Unit 120

The control unit 120 controls operations of the support base 40, the magazine 50, the pusher 60, the insertion mechanism 100, the first camera 111, and the second camera 112. When detecting that a set of the magnets 20 is in contact with the lower surface of the pressing member 70, the proximity sensor 71 sends a detection signal to the control unit 120. Data of images captured by the first camera 111 and the second camera 112 is sent to the control unit 120.

The control unit 120 includes processing circuitry that includes a computer and a memory, and controls various operations executed by the magnet insertion device 30 according to programs stored in the memory.

### Operation of Magnet Insertion Device 30

Operation of the magnet insertion device 30 will now be described.

As shown in FIG. 2, in order to insert magnets 20 into a magnet housing hole 13 of the rotor core 11, the control unit 120 first raises the extruding portions 54. The uppermost set of the magnets 20, extruded from the housing body 51 by the extruding portions 54 moving upward, comes into contact with the lower surface of the pressing member 70. In other words, a set of the magnets 20 moves to the push position. As a result, the proximity sensor 71 outputs a detection signal to the control unit 120.

When receiving the detection signal, the control unit 120 determines that the set of the magnets 20 is positioned at the push position and stops the operation of the extruding portions 54. Thus, the movement of the magnets 20 in the stacking direction is stopped. Next, the control unit 120 advances the pusher 60. Accordingly, the set of the collective magnets 20 is pushed by the pusher 60, and thus moves along the guide groove 91 of the guide member 90. Thereafter, the end portion of the set of the magnets 20 passes through the passage port 81 of the aligning member 80. A pushed distance of the set of the magnets 20 by the pusher 60 is set such that the set of the magnets 20 protrudes from the passage port 81 without falling out from the passage port 81.

The magnets 20 in the set are aligned in the arrangement direction and the vertical direction by passing through the passage port 81. The magnets 20 in the set are aligned in the pushing direction of the pusher 60 by being collectively pushed by the pusher 60.

Next, the control unit 120 causes the chuck 101 of the insertion mechanism 100 to grip the end portions of the set of the magnets 20 protruding from the passage port 81. At this time, first, the pair of the second gripping portions 103 grips the set of the magnets 20. Thereafter, the pair of the first gripping portions 102 grips the set of the magnets 20 while the chuck 101 pulls out the set of the magnets 20 from the passage port 81.

Next, as shown in FIG. 6, the control unit 120 operates the robotic arm 104 to move the set of the magnets 20 held by the chuck 101 such that the end face of the set of the magnets 20 faces the first camera 111.

Subsequently, the control unit 120 causes the first camera 111 to capture an image of the end face of the set of the magnets 20. The control unit 120 causes the second camera 112 to capture an image of the upper surface of the rotor core 11.

First image data, which is data of an image of the end face of the set of the magnets 20 captured by the first camera 111, and second image data, which is data of an image of the upper surface of the rotor core 11 captured by the second camera 112, are sent to the control unit 120. Based on the first image data, the control unit 120 calculates the geometric center of the end face of the entire set of the magnets 20 as a first central axis L1 of the end face. Further, based on the second image data, the control unit 120 calculates the geometric center of the opening of the magnet housing hole 13 into which the set of the magnets 20 will be inserted as a second central axis L2 of the opening.

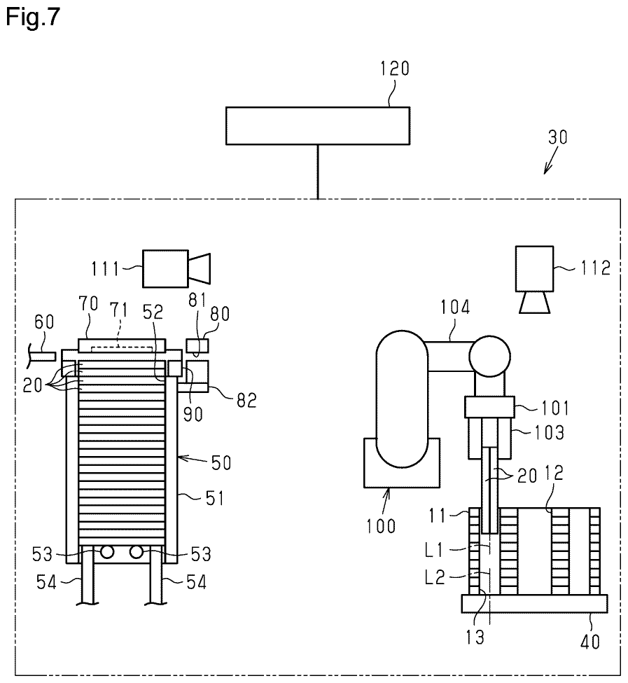

Next, as shown in FIG. 7, the control unit 120 operates the robotic arm 104 to move the set of the magnets 20 to a position where the first central axis L1 of the set of the magnets 20 agrees with the second central axis L2 of the magnet housing hole 13. At this time, the control unit 120 rotates the chuck 101 such that the arrangement direction of the set of the magnets 20 agrees with the longitudinal direction of the magnet housing hole 13.

Then, the control unit 120 operates the robotic arm 104 to insert the set of the magnets 20 into the magnet housing hole 13 in a state in which the first central axis L1 and the second central axis L2 agree with each other. The set of the magnets 20 inserted into the magnet housing hole 13 may be separated from each other inside the magnet housing hole 13.

Subsequently, the control unit 120 retracts the chuck 101 from the rotor core 11 and rotates the support base 40 by a predetermined rotation angle in order to insert a set of the magnets 20 into the next magnet housing hole 13.

As the above-described operation is repeated, sets of the magnets 20 are inserted one by one into the respective magnet housing holes 13 of the rotor core 11.

Operation of the present embodiment will now be described.

When the set of the magnets 20 extruded to the outside of the housing body 51 by the extruding portions 54 is collectively pushed and moved by the pusher 60, the magnets 20 are aligned by the aligning member 80. The aligned set of the magnets 20 is collectively gripped by the insertion mechanism 100. As a result, the insertion mechanism 100 inserts the aligned set of the magnets 20 into a magnet housing hole 13.

The present embodiment has the following advantages.

(1) The magazine 50 includes the housing body 51, which houses multiple magnets 20 in a stacked state, and the two extruding portions 54 that sequentially extrude sets of the magnets 20 to the outside of the housing body 51 in a state in which the magnets 20 in each set are arranged side by side. The pusher 60 moves each set of the magnets 20 by collectively pushing the set of the magnets 20, which has been extruded to the outside of the housing body 51, in a direction different from the stacking direction. The aligning member 80 aligns the magnets 20 in the set by coming into contact with the opposite sides in the arrangement direction of the set of the magnets 20, which is being pushed and moved by the pusher 60. The insertion mechanism 100 collectively grips the magnets 20 in the set, which have been aligned by the aligning member 80, and inserts the magnets 20 into a magnet housing hole 13.

This configuration operates in the above-described manner, so that, sets of the magnets 20 are smoothly inserted into the respective magnet housing holes 13.

(2) The guide member 90 guides each set of the magnets 20 toward the aligning member 80 by restricting displacement in the arrangement direction of the set of the magnets 20 when the magnets 20 are being pushed and moved by the pusher 60.

With this configuration, when each set of the magnets 20 is pushed and moved by the pusher 60, the set of the magnets 20 is guided to the aligning member 80 by the guide member 90. The aligning member 80 thus aligns the magnets 20 in each set in a favorable manner.

(3) The insertion mechanism 100 includes the pair of the first gripping portions 102, which grips a set of the magnets 20 from the opposite sides in the direction orthogonal to both the pushing direction of the pusher 60 and the arrangement direction, and the pair of the second gripping portions 103, which clamps and grips the set of the magnets 20 from the opposite sides in the arrangement direction. The contact area between the first gripping portions 102 and the set of the magnets 20 is larger than the contact area between the second gripping portions 103 and the set of the magnets 20. The gripping force of the pair of the first gripping portions 102 is greater than the gripping force of the pair of the second gripping portions 103.

With this configuration, the first gripping portions 102 have a larger contact area with the set of the magnets 20 and a greater gripping force than the second gripping portions 103. Therefore, the positional misalignment of the set of the magnets 20 gripped by the insertion mechanism 100 is suppressed in a favorable manner.

In addition, the set of the magnets 20 is gripped by the pair of the second gripping portions 103 in addition to the pair of the first gripping portions 102. Thus, positional misalignment between the magnets 20 due to an inertial force such as a centrifugal force is suppressed when the insertion mechanism 100 moves the set of the magnets 20.

(4) The pressing member 70 is disposed at a position facing the ejection port 52, and presses down a set of the magnets 20, which is pushed and moved by the pusher 60, from one side in the stacking direction.

With this configuration, the set of the magnets 20 pushed and moved by the pusher 60 is prevented from fluttering. Accordingly, the set of the magnets 20 is smoothly moved toward the aligning member 80.

(5) The insertion mechanism 100 inserts a set of the magnets 20 into a magnet housing hole 13 in a state in which the first central axis L1 of the end face of the entire set of the magnets 20 in the insertion direction agrees with the second central axis L2 of the magnet housing hole 13.

With this configuration, the set of the magnets 20 is inserted into the magnet housing hole 13 in a state in which the first central axis L1 of the end face of the entire set of the magnets 20 aligned in advance agrees with the second central axis L2 of the magnet housing hole 13. This allows the set of the magnets 20 to be smoothly inserted into the magnet housing hole 13.

### Modifications

The above-described embodiment may be modified as follows. The above-described embodiment and the following modifications can be combined as long as the combined modifications remain technically consistent with each other.

The insertion mechanism 100 may be configured to insert a set of the magnet 20 into a magnet housing hole 13 by moving the magnets 20 to a predetermined position.

In place of the proximity sensor 71, the magnet insertion device 30 may include a sensor that detects that the uppermost set of the magnets 20 is located at the push position. An example of such a sensor is a photoelectric sensor.

The pressing member 70 does not necessarily need to include the proximity sensor 71. In this case, the extruding portions 54 may move the magnets 20 by a predetermined movement amount.

The magnet insertion device 30 does not necessarily need to include the pressing member 70.

The gripping force of the pair of the second gripping portions 103 may be greater than the gripping force of the pair of the first gripping portions 102. In addition, the gripping force of the first gripping portions 102 and the gripping force of the second gripping portions 103 may be the same.

The insertion mechanism 100 may include only one of the pair of the first gripping portions 102 and the pair of the second gripping portions 103.

The magnet insertion device 30 does not necessarily need to include the guide member 90.

The magazine 50 may include one extruding portion 54. In this case, one extruding portion 54 is preferably disposed between the two support portions 53.

The magazine 50 of the above-described embodiment accommodates the multiple magnets 20 in a state of being stacked in the vertical direction. However, the magazine 50 may accommodate the multiple magnets 20 in a state in which the arrangement direction and the stacking direction of sets of the magnets 20 agree with each other. In this case, for example, the arrangement direction and the stacking direction of the sets of the magnets 20 may agree with the horizontal direction.

A gap may be provided between the inner surface of the passage port 81 and the upper surface of the set of the magnets 20.

An elastic member that elastically contacts at least one of the magnets 20 in a set may be provided on the inner surface of the passage port 81. In this configuration, dimensional variations in the magnets 20 are absorbed. Consequently, excessive sliding between the magnets 20 and the inner surface of the passage port 81 is suppressed.

One set of the magnets 20 may include three or more magnets 20.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A magnet insertion device configured to insert sets of magnets into magnet housing holes formed in a rotor core, the magnet insertion device comprising:
a magazine that includes:
a housing body that has an ejection port and is configured to house multiple magnets in a stacked state; and
an extruding portion configured to move the magnets in the housing body in a stacking direction to sequentially extrude the sets of the magnets from the housing body through the ejection port in a state in which the magnets in each set are arranged side by side;
a pusher configured to move, in a direction different from the stacking direction, each set of the magnets by collectively pushing the magnets extruded to the outside of the housing body;
an aligning member configured to align the magnets in each set by coming into contact with opposite sides in the arrangement direction of the set of the magnets when the magnets are pushed and moved by the pusher; and
an insertion mechanism configured to collectively grip the magnets in each set that have been aligned by the aligning member, and to insert the magnets into one of the magnet housing holes.

2. The magnet insertion device according to claim 1, further comprising a guide member configured to guide each set of the magnets toward the aligning member by restricting displacement of the magnets in the arrangement direction when the magnets are pushed and moved by the pusher.

3. The magnet insertion device according to claim 1, wherein
the insertion mechanism includes:
a pair of first gripping portions configured to grip each set of the magnets from opposite sides in a direction orthogonal to both a pushing direction of the pusher and the arrangement direction; and
a pair of second gripping portions configured to clamp and grip each set of the magnets from opposite sides in the arrangement direction,
a contact area between the first gripping portions and the set of the magnets is larger than a contact area between the second gripping portions and the set of the magnets, and
a gripping force of the pair of the first gripping portions is greater than a gripping force of the pair of the second gripping portions.

4. The magnet insertion device according to claim 1, further comprising a pressing member that is disposed at a position facing the ejection port and is configured to press down, from one side in the stacking direction, each set of the magnets when the magnets are pushed and moved by the pusher.

5. The magnet insertion device according to claim 1, wherein the insertion mechanism is configured to insert each set of the magnets into one of the magnet housing holes in a state in which a central axis of an end face of the entire set of the magnets in an insertion direction agrees with a central axis of the magnet housing hole.
